(19) United States
(12) Patent Application Publication
(10) Pub. No.: US 2018/0112704 A1
(43) Pub. Date: Apr. 26, 2018

(54) LOCKING NUT DEVICE AND METHOD

(71) Applicant: FORD GLOBAL TECHNOLOGIES, LLC, Dearborn, MI (US)

(72) Inventors: Brian Siler, Richmond, MI (US); Patrick Reed, Livonia, MI (US); Michael J. Presley, Plymouth, MI (US); David Wayne Raffler, Shelby Township, MI (US)

(21) Appl. No.: 15/334,008

(22) Filed: Oct. 25, 2016

(51) Int. Cl. F16B 39/282; B60R 3/00

(52) U.S. Cl. CPC F16B 39/282; B60R 3/002

(57) ABSTRACT

A locking nut device includes a body having a locking tab feature at a first end and a threaded aperture and antirotation tab feature at a second end. The locking nut device may be utilized in a method of mounting a first work piece to a second work piece where that second work piece includes first and second adjacent apertures.

### TECHNICAL FIELD

This document relates generally to the fastener field and, more particularly, to a locking nut device adapted to secure a first work piece to a second work piece wherein that second work piece includes a first aperture adjacent a second aperture.

### BACKGROUND

Often one needs to secure a first work piece to a second work piece where the second work piece includes first and second adjacent apertures in an otherwise closed and inaccessible cavity.

This document relates to an adjacent hole locking nut device specifically adapted to achieve this end. Such a device is particularly useful in a method of mounting a first work piece to a second work piece in a quick and efficient manner. For example, the locking nut device may be utilized to add running boards to an existing vehicle platform or frame without modifying the vehicle or frame and providing designed attachment accommodations. Advantageously, the locking nut device and the related method of mounting a first work piece to a second work piece is simple, convenient and ergonomically friendly.

### SUMMARY

In accordance with the purposes and benefits described herein, a locking nut device is provided. That locking nut device comprises a body including (a) a locking tab feature at a first end and (b) a threaded aperture and an antirotation tab feature at a second end. In one possible embodiment of the locking nut device, the body may include an arcuate intermediate section between the first end and the second end. Further, the locking tab feature may comprise a first locking tab and a second locking tab.

The first locking tab may be parallel to the second locking tab. Further, the first locking tab and the second locking tab may be oriented toward the second end.

In addition, a slot may be defined between (a) the arcuate intermediate section and (b) the first locking tab and the second locking tab. That slot may open toward the second end.

Still further, the first end and the second end may extend in a first plane. Further, the first locking tab and the second locking tab may extend in a second plane. In addition, the arcuate intermediate section may be concave toward the first locking tab and the second locking tab.

In another possible embodiment, the locking tab feature may include a first locking tab and a second locking tab. The first end and the second end of the body may extend in a first plane. The first locking tab and the second locking tab may extend in a second plane. Further, the first locking tab and the second locking tab may be opposed.

In addition, the first end and the second end may lie on a first axis while the first locking tab and the second locking tab may lie on a second axis. That first axis may be perpendicular to the second axis.

In accordance with an additional aspect, a method is provided of mounting a first work piece to a second work piece when the second work piece includes a first aperture and a second, adjacent aperture. That method may include the steps of: (a) inserting a second end of a locking nut device into the first aperture (b) aligning a threaded aperture in the second end with the second aperture and (c) locking the locking nut device to the second work piece.

Still further the method may include the step of engaging a locking tab feature on a first end of the locking nut device with the second work piece adjacent the first aperture in order to lock the locking nut device to the second work piece.

Still further, the method may include the step of securing the first work piece to the second work piece by means of a fastener engaged in the threaded aperture in the second end of the locking nut device.

In accordance with still another aspect, a method is provided of mounting a running board to a frame of a motor vehicle. That method comprises the steps of: (a) inserting a second end of a locking nut device into a first aperture of the frame, (b) aligning a threaded aperture in the second end with a second aperture in the frame and (c) securing the locking nut device in the frame by engaging a locking tab feature on a first end of the locking nut device with the frame adjacent the first aperture.

The method may further include the step of securing the running board to the frame by engaging a fastener with the threaded aperture. In addition, the method may include the step of pivoting the locking nut device in the first aperture in order to align the threaded aperture with the second aperture in the frame. Further, the method may include extending the locking nut device along an inner surface of the frame between the first aperture and the second aperture. That inner surface may be a closed section area or cavity with limited accessibility.

In the following description, there are shown and described several preferred embodiments of the locking nut device as well as the related method of mounting a first work piece or running board to a second work piece or frame of a motor vehicle. As it should be realized, the locking nut device and related method are capable of other, different embodiments and their several details are capable of modification in various, obvious aspects all without departing from the locking nut device and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the locking nut device as well as the related methods and together with the description serve to explain certain principles thereof. In the drawing figures:

FIG. 1 is a perspective view of a first embodiment of the locking nut device including a locking feature incorporating two parallel locking tabs.

FIG. 2 is a side elevational view of the locking nut device illustrated in FIG. 1.

FIGS. 3a-3c are a series of views illustrating a method of mounting a first work piece, in this case a running board, to a second work piece, in this case a frame of a motor vehicle.

FIG. 4 is a perspective view of another embodiment of a locking nut device.

FIG. 5 is a side elevational view of the locking nut device illustrated in FIG. 4.

FIGS. 6a and 6b are views illustrating a method of mounting a running board to a frame of a motor vehicle utilizing the second embodiment of the locking nut device illustrated in FIGS. 4 and 5.

Reference will now be made in detail to the present preferred embodiments of the locking nut device and the related methods, examples of which are illustrated in the accompanying drawing figures.

### DETAILED DESCRIPTION

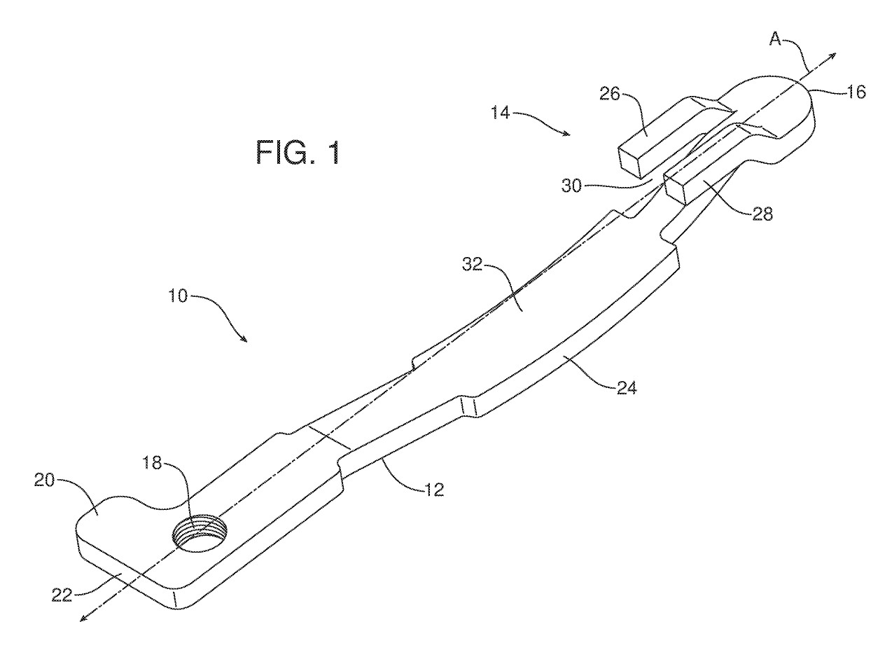

Reference is now made to FIGS. 1-3c illustrating a first embodiment of a locking nut device 10. The locking nut device has a body 12 including a locking tab feature 14 at a first end 16 and a threaded aperture 18 and an antirotation tab feature 20 at a second end 22. As further illustrated, the body 12 includes an arcuate intermediate section 24 between the first end 16 and the second end 22.

The locking tab feature 14 includes a first locking tab 26 and a second locking tab 28. In the embodiment illustrated in FIGS. 1-3c, the first and second locking tabs 26, 28 are parallel and oriented so as to project toward the second end 22.

As further illustrated in FIGS. 1-3c, the locking nut device 10 includes a slot 30 defined between (a) the arcuate intermediate section 24 and (b) the first locking tab 26 and the second locking tab 28. As shown, the slot 30 opens toward the second end 22.

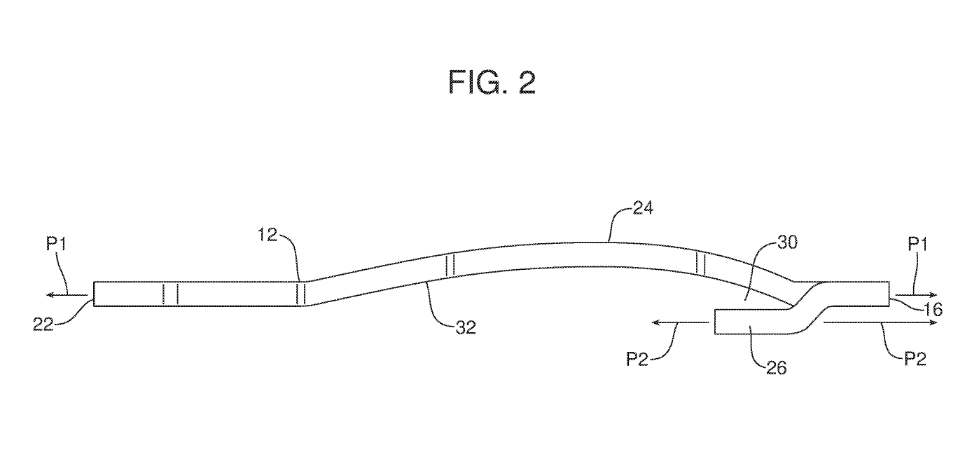

As should be further appreciated, the first end 16 and the second end 22 extend in a first plane P1 while the first locking tab feature 14, including the first locking tab 26 and the second locking tab 28, extend in a second plane P2 (see FIG. 2). Further, the arcuate intermediate section 24 is oriented with the concave face 32 of the body 12 directed toward the locking tab feature 14 including the first locking tab 26 and second locking tab 28.

In the embodiment illustrated in FIGS. 1-3c, the antirotation tab feature 20 takes the form of a lug projecting in the first plane at an angle substantially perpendicular to the longitudinal axis A of the body 12.

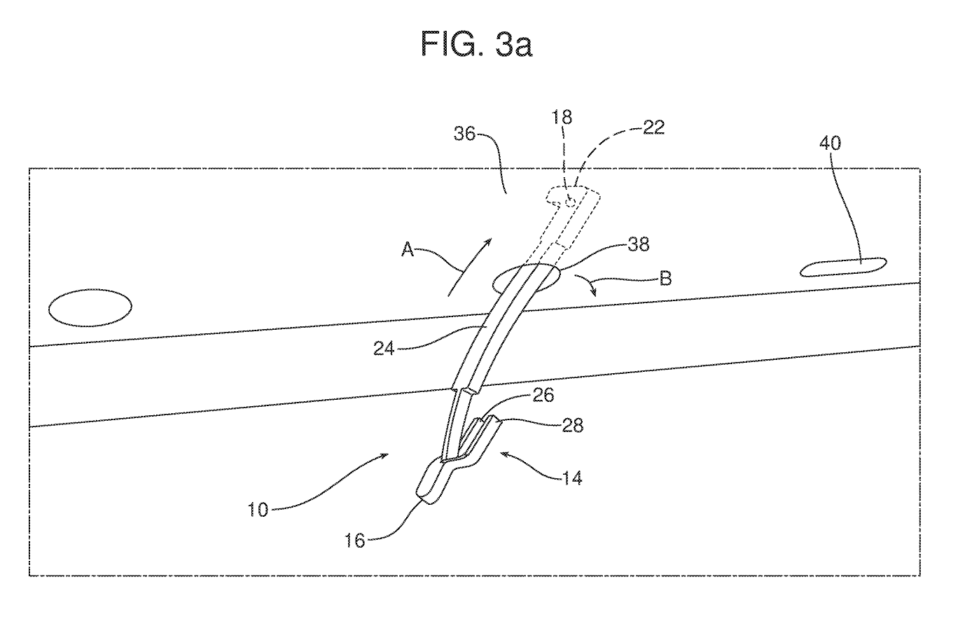

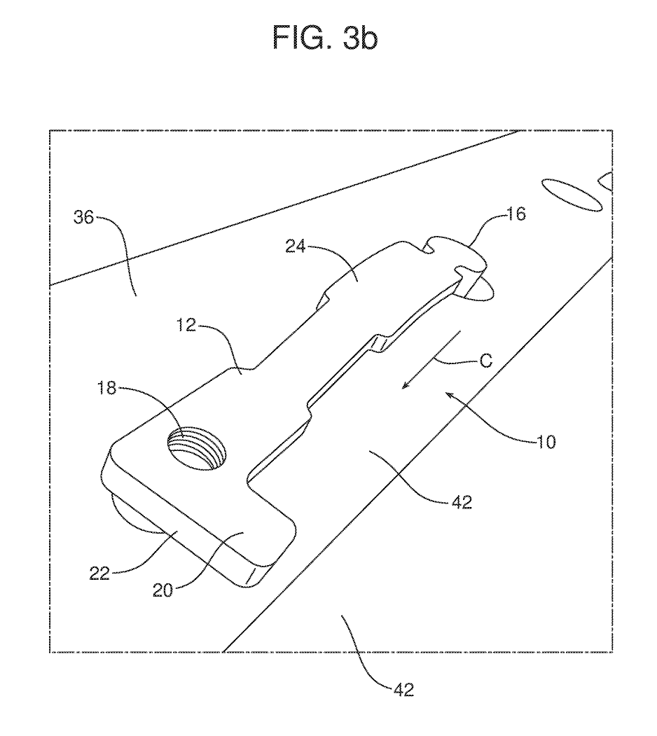

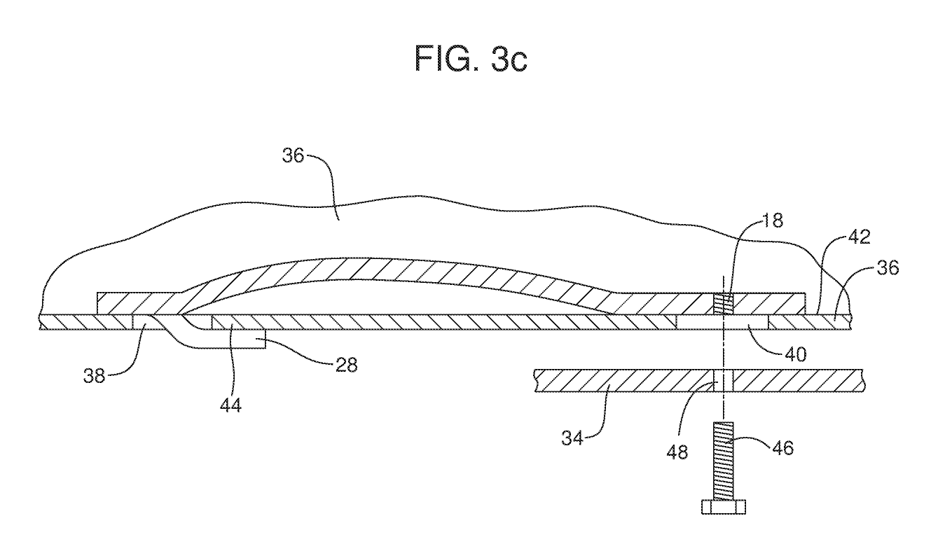

Reference is now made to FIGS. 3a-3c illustrating how the locking nut device 10 illustrated in FIGS. 1 and 2 is utilized in a method of mounting a first work piece 34 to a second work piece 36. In the illustrated embodiment, the first work piece 34 comprises a running board while the second work piece comprises a frame of a motor vehicle.

As illustrated, the frame/second work piece 36 includes a first aperture 38 adjacent a second aperture 40.

The mounting method includes the initial step of inserting the second end 22 of the locking nut device 10, including the antirotation tab feature 20, into the first aperture 38. Next, as illustrated in FIG. 3b, is the step of aligning the threaded aperture 18 in the second end 22 of the body 12 with the second aperture 40. To achieve this end, one continues to insert the locking nut device 10 into the first aperture 38 as illustrated by action arrow A in FIG. 3a while simultaneously pivoting the locking nut device 10 in the first aperture in the direction of action arrow B until the body 12 of the locking nut device extends along the inner surface 42 of frame/second work piece 36 (as shown in FIGS. 3b and 3c).

The locking nut device 10 is then locked to the frame/second work piece 36 by shifting the locking nut device 10 in the direction of action arrow C until the margin 44 of the frame/second work piece 36 defining the first aperture 38 is received and held in the slot 30 between the first and second locking tabs 26, 28 of the locking tab feature 14 and the arcuate intermediate section 24 of the body 12. As should be appreciated, the engagement of the margin 44 within the slot 30 cooperates with the antirotation tab feature 20 to hold the threaded aperture 18 aligned with the second aperture 40. As a result, a fastener in the form of the bolt 46 may be passed through a mounting aperture 48 in the running board/first work piece 34 and threadedly engaged in the threaded aperture 18. After tightening the bolt 46 down, the running board/first work piece 34 is secured to the frame/second work piece 36 by capturing the margin of the running board/first work piece defining the aperture 48 between the head 52 of the bolt 46 and the frame/second work piece/36.

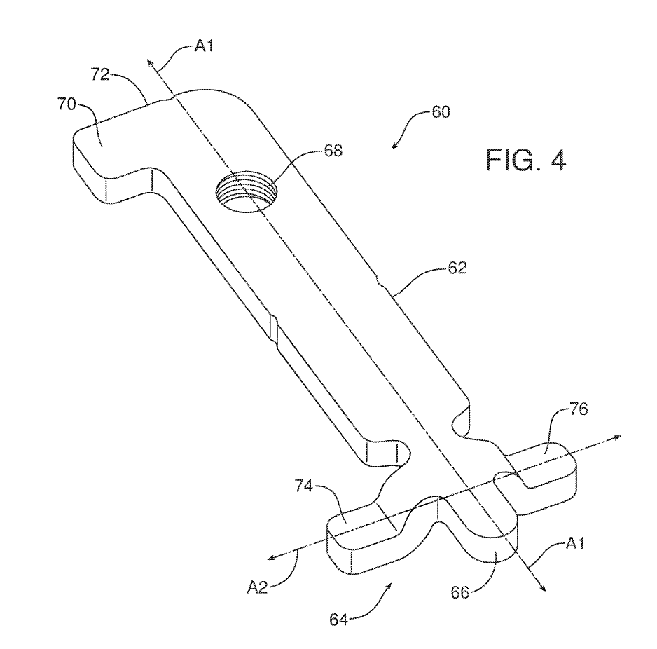

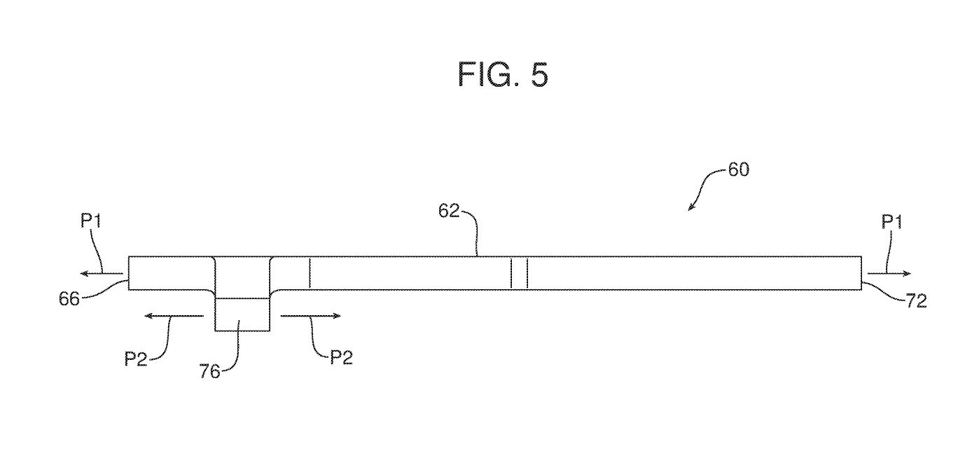

Reference is now made to FIGS. 4 and 5 illustrating a second embodiment of a locking nut device 60. As illustrated, the locking nut device 60 includes a body 62 having a locking nut feature 64 at a first end 66 and a threaded aperture 68 and antirotation tab feature 70 at a second end 72.

The locking nut feature 64 includes a first locking tab 74 and a second locking tab 76. The first end 66 and second end 72 of the body 62 extend in a first plane P1 while the first locking tab 74 and the second locking tab 76 of the locking tab feature 64 extend in a second plane P2. Further, the first locking tab 74 and second locking tab 76 are opposed.

As further shown, the first end 66 and the second end 72 lie on a first axis A1 while the first locking tab 74 and second locking tab 76 lie on a second axis A2. In the illustrated embodiment the first axis A1 is perpendicular to the second axis A2. In addition, in this embodiment the body 62 is planer and does not include an arcuate intermediate section 24 as is provided in the first embodiment of the locking nut device 10 illustrated in FIGS. 1 and 2.

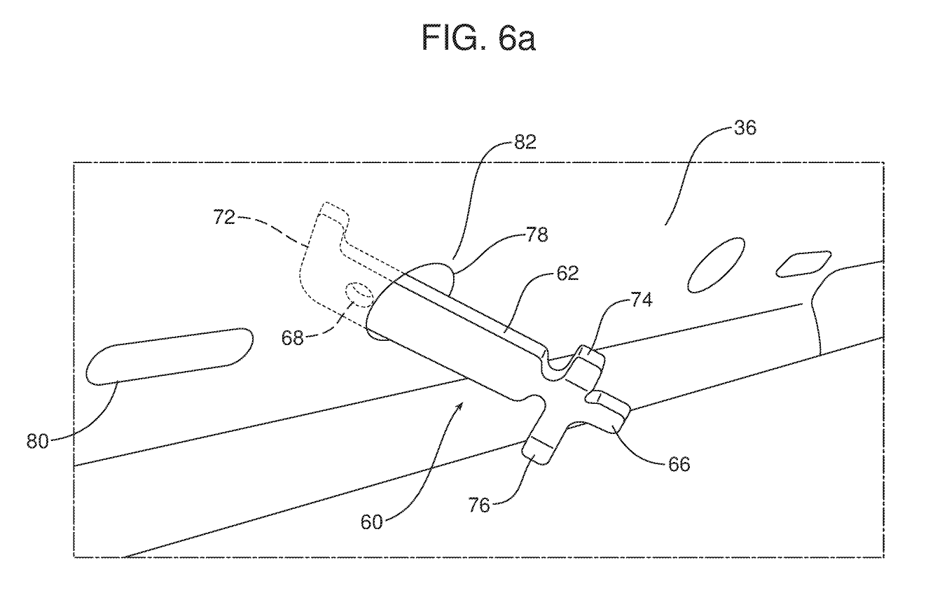

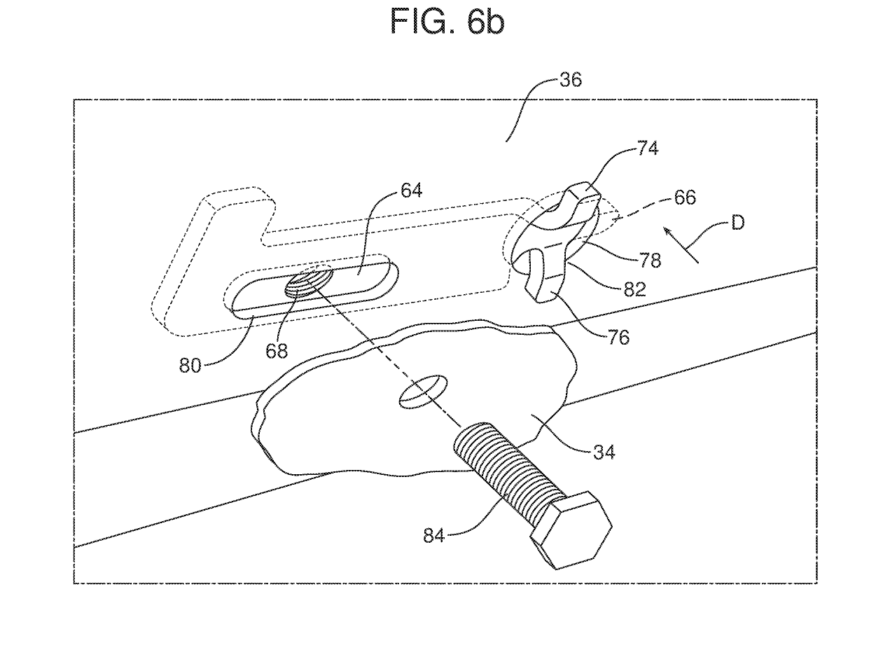

FIGS. 6a and 6b illustrate use of the locking nut device 60 in a method of mounting a running board or first work piece 34 to a frame or second work piece 36 including a first aperture 78 and a second aperture 80. As shown, the second end 72 including the antirotation tab feature 70 is initially inserted in the first aperture 78. The locking nut device 60 is then further inserted and pivoted in order to align the threaded aperture 68 in the second end 72 with the second aperture 80 until the locking tab feature 64, including the first locking tab 74 and second locking tab 76 is engaged with the margin 82 of the frame/second work piece 36 outlining or forming the first aperture 78 as illustrated in FIG. 6b.

Here, it should be appreciated that the engagement of the locking tab feature 64 with the margin 82 functions with the antirotation tab feature 70 to maintain the threaded aperture 68 aligned with and accessible through the second aperture 80 as the running board/first work piece 34 is secured in place by threadedly engaging the bolt 84 in the threaded aperture 68 and tightening the bolt. More specifically, one simply presses the first end 66 toward the frame/second work piece 36 (note action arrow D) to hold the locking nut device 10 in place and maintain the threaded aperture 68 in a desired position to complete the connection.

As should be appreciated from the foregoing, the embodiments of a locking nut device 10, 60 allow one to simply and easily mount a first work piece 34 such as a running board to a second work piece 36 such as a frame where that second work piece includes two adjacent apertures 38, 40, or 78, 80. Advantageously, this can be done without modifying the frame/second work piece 36 in any manner and even without previously providing any designed attachment accommodations. Further, it should be appreciated that the locking nut device 10, 60 allows one to accomplish this end even when the frame/second work piece 36 defines a closed section area or cavity that is virtually inaccessible in any other way.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A locking nut device, comprising:
a body including (a) a locking tab feature at a first end and (b) a threaded aperture and antirotation tab feature at a second end.

2. The locking nut device of claim 1, wherein said body includes an arcuate intermediate section between said first end and said second end.

3. The locking nut device of claim 2, wherein said locking tab feature comprises a first locking tab and a second locking tab.

4. The locking nut device of claim 3, wherein said first locking tab is parallel to said second locking tab.

5. The locking nut device of claim 4, wherein said first locking tab and said second locking tab are oriented toward said second end.

6. The locking nut device of claim 5, wherein a slot is defined between (a) said arcuate intermediate section and (b) said first locking tab and said second locking tab, said slot opening toward said second end.

7. The locking nut device of claim 6, wherein said first end and said second end extend in a first plane, said first locking tab and said second locking tab extend in a second plane and said arcuate intermediate section is concave toward said first locking tab and said second locking tab.

8. The locking nut device of claim 1, wherein said locking tab feature includes a first locking tab and a second locking tab.

9. The locking nut device of claim 8, wherein said first end and said second end extend in a first plane.

10. The locking nut device of claim 9, wherein said first locking tab and said second locking tab extend in a second plane.

11. The locking nut device of claim 10, wherein said first locking tab is opposed to said second locking tab.

12. The locking nut device of claim 11, wherein said first end and said second end lie on a first axis and said first locking tab and said second locking tab lie on a second axis.

13. The locking nut device of claim 12, wherein said first axis is perpendicular to said second axis.

14. A method of mounting a first work piece to a second work piece wherein said second work piece includes a first aperture and a second aperture, comprising:
inserting a second end of a locking nut device into said first aperture;
aligning a threaded aperture in said second end with said second aperture; and
locking said locking nut device to said second work piece.

15. The method of claim 14, further including engaging a locking tab feature on a first end of said locking nut device with said second work piece adjacent said first aperture.

16. The method of claim 15, including securing said first work piece to said second work piece by means of a fastener engaged in said threaded aperture in said second end of said locking nut device.

17. A method of mounting a running board to a frame of a motor vehicle, comprising:
inserting a second end of a locking nut device into a first aperture of said frame;
aligning a threaded aperture in said second end with a second aperture in said frame; and
securing said locking nut device in said frame by engaging a locking tab feature on a first end of said locking nut device with said frame adjacent said first aperture.

18. The method of claim 17, further including securing said running board to said frame by engaging a fastener with said threaded aperture.

19. The method of claim 18, further including pivoting said locking nut device in said first aperture in order to align said threaded aperture with said second aperture in said frame.

20. The method of claim 19, further including extending said locking nut device along an inner surface of said frame between said first aperture and said second aperture.
